(19) United States
(12) Patent Application Publication
(10) Pub. No.: US 2012/0013842 A1
(43) Pub. Date: Jan. 19, 2012

(54) Eyeglasses with Reverse Curvature Temple Pieces

(76) Inventor: Linda Haynie Green, Pell City, AL (US)

(21) Appl. No.: 13/181,676

(22) Filed: Jul. 13, 2011

Related U.S. Application Data
(60) Provisional application No. 61/364,065, filed on Jul. 14, 2010.

(51) Int. Cl. G02C 5/14

(52) U.S. Cl. 351/121

(57) ABSTRACT

A pair of eyeglasses comprising one frame; two lenses, wherein said two lenses are attached to said frame; one nose piece wherein said nose piece is attached to said frame between said two lenses; and two temple pieces wherein each temple piece comprises a first end and a second end; said first ends of said two temple pieces connected to said frame; said second ends of said two temple pieces convexly curved with respect to one another.

### CROSS-REFERENCE TO RELATED APPLICATIONS

This application claims the benefit of U.S. Provisional Application No. 61/364,065, entitled “Eyeglasses with Reverse Curvature Temple Pieces” and filed Jul. 14, 2010. The complete disclosure of said provisional patent application is hereby incorporated by reference.

### STATEMENT REGARDING FEDERALLY SPONSORED RESEARCH OR DEVELOPMENT

Not applicable

### BACKGROUND OF THE INVENTION

This invention relates to eyeglasses, and more particularly, to eyeglasses with reverse curvature temple pieces.

The basic components of glasses in the prior art include two lenses within a frame, a nose piece attached to the frame between the lenses, and two temple pieces that hold the glasses to the wearer's face. The prior art teaches two major types of temple pieces: pieces that wrap around the ear, and short pieces that run straight along the temple but do not reach over the ear.

One of the disadvantages of wearing glasses with short temple pieces that do not reach around the ear is the deep indentation in the facial skin of the wearer of the glasses that results because of the increased pressure required to hold the glasses on the wearer's face.

It therefore would be desirable to develop a reverse curvature short temple piece that attaches to a pair of eyeglasses that will hold the eyeglasses to the wearer's face but does not cause indentations in the facial skin of the wearer.

### BRIEF SUMMARY OF THE INVENTION

In a first preferred embodiment, the present invention is directed to a pair of eyeglasses comprising: (a) two lenses; (b) one nose piece wherein said nose piece is attached between said two lenses; and (c) two temple pieces wherein each temple piece comprises a first end and a second end; said first ends of said two temple pieces connected to said two lenses; said second ends of said two temple pieces are convexly curved with respect to one another.

In a second preferred embodiment, the present invention is directed to a pair of eyeglasses comprising: (a) one frame; (b) two lenses, wherein said two lenses are attached to said frame; (c) one nose piece wherein said nose piece is attached to said frame between said two lenses; and (d) two temple pieces wherein each temple piece comprises a first end and a second end; said first ends of said two temple pieces connected to said frame; said second ends of said two temple pieces convexly curved with respect to one another.

In a third preferred embodiment, the present invention is directed to a temple piece comprising a first end and a second end wherein said first end of said temple piece is capable of being attached to a frame at said first end, and said second end of said temple piece curves away from the junction formed between said first end of said temple piece and said frame when said temple piece is attached to said frame.

### BRIEF DESCRIPTION OF THE DRAWINGS

FIG. 1 is a front view of glasses with a reverse curvature short temple piece according to the preferred embodiment of the present invention.

FIG. 2 is a top view of glasses with a reverse curvature short temple piece according to the preferred embodiment of the present invention.

### DETAILED DESCRIPTION OF THE INVENTION

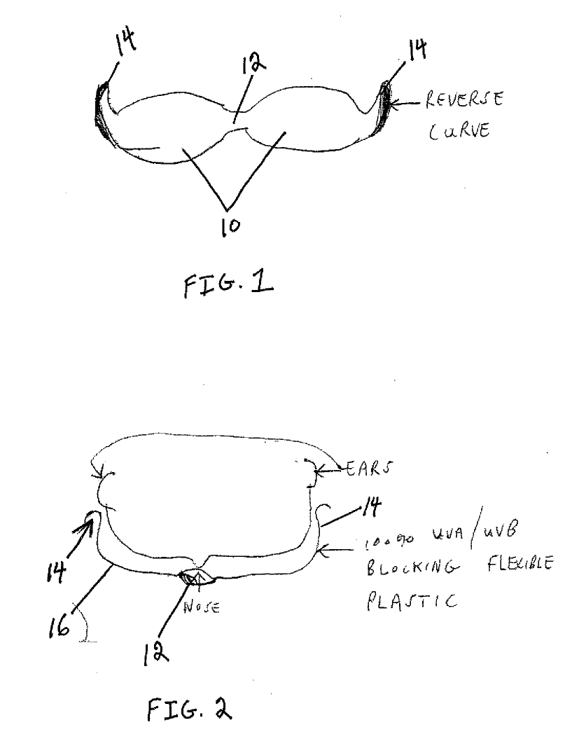

With reference to FIGS. 1-2, the preferred embodiments of the present invention may be described. The glasses of the present invention comprises two lenses 10, a nose piece 12 between the two lenses, and two short reverse curvature temple pieces 14. In an alternative embodiment, the glasses comprise a frame 16 to hold the two lenses 10. Thus, the nose piece 12 and temple pieces 14 may be attached to either the frame 16 or directly to the lenses 10. The temple pieces 14 are attached via a hinge or by other means which are well-known in the art.

Each temple piece 14 has a first end and a second end. The first ends of the temple pieces 14 attach to the lenses 10 or to the frame 16. As shown in FIG. 2, the second ends of the temple pieces 14 are convexly curved with respect to one another (i.e. curve outward and away from one another).

As each temple piece 14 approaches the ear, the second end of the temple piece curves away from the wearer's face creating the reverse curvature feature of the invention. This feature relieves pressure on the temples of the wearer of the glasses. In the preferred embodiments of the invention, the temple pieces are made from a flexible plastic that is 100% UVA/UVB blocking.

As used herein, “eyeglasses” and “glasses” refers to regular eyeglasses, sunglasses, and safety glasses.

The present invention has been described with certain preferred and alternative embodiments that are intended to be exemplary only and not limiting to the full scope of the invention.

We claim:

1. A pair of eyeglasses comprising:
(a) two lenses;
(b) one nose piece wherein said nose piece is attached between said two lenses; and
(c) two temple pieces wherein each temple piece comprises a first end and a second end; said first ends of said two temple pieces connected to said two lenses; said second ends of said two temple pieces convexly curved with respect to one another.

2. The eyeglasses of claim 1 wherein said two temple pieces are comprised of flexible plastic material.

3. The eyeglasses of claim 2 wherein said flexible plastic material is 100% UVA/UVB blocking.

4. A pair of eyeglasses comprising:
(a) one frame;
(b) two lenses, wherein said two lenses are attached to said frame;
(c) one nose piece wherein said nose piece is attached to said frame between said two lenses; and
(d) two temple pieces wherein each temple piece comprises a first end and a second end; said first ends of said two temple pieces connected to said frame; said second ends of said two temple pieces convexly curved with respect to one another.

5. The eyeglasses of claim 4 wherein said two temple pieces are comprised of flexible plastic material.

6. The eyeglasses of claim 4 wherein said flexible plastic material is 100% UVA/UVB blocking.

7. A temple piece comprising a first end and a second end wherein said first end of said temple piece is capable of being attached to a frame at said first end, and said second end of said temple piece curves away from the junction formed between said first end of said temple piece and said frame when said temple piece is attached to said frame.

8. The temple piece of claim 7 wherein said temple piece is comprised of flexible plastic material.

9. The temple piece of claim 8 wherein said flexible plastic material is 100% UVA/UVB blocking.
